(19) United States
(12) Patent Application Publication
(10) Pub. No.: US 2026/0062351 A1
(43) Pub. Date: Mar. 5, 2026

(54) HYDRAULIC CEMENT FOR CARBON DIOXIDE ENVIRONMENTS

(71) Applicant: Halliburton Energy Services, Inc., Houston, TX (US)

(72) Inventors: Sourav Ghosh, Pune (IN); Sudhir Nimane, Pune (IN)

(21) Appl. No.: 18/816,663

(22) Filed: Aug. 27, 2024

(51) Int. Cl. C04B 24/12; C04B 28/04; C04B 103/61; C04B 111/00; C04B 111/22; C09K 8/467; E21B 33/14

(52) U.S. Cl. CPC C04B 24/122; C04B 28/04; C09K 8/467; C04B 2103/61; C04B 2111/00146; C04B 2111/22; E21B 33/14

(57) ABSTRACT

A hydraulic cement composition is provided. The composition comprises a hydraulic cement and an anti-corrosion agent selected from the group consisting of one or more alkanolamines, one or more derivatives of alkanolamines, and combinations thereof. The composition can be mixed with water to form a carbon dioxide-resistant hydraulic cement slurry. A hydraulic cement slurry and a method of cementing in a carbon dioxide environment are also provided.

### BACKGROUND

Hydraulic cement compositions, which set and harden after interacting with water, are commonly utilized in oil, gas, and water well completion and remedial operations. A typical hydraulic cement composition is in the form of a slurry that includes hydraulic cement, water, and one or more additives that affect one or more properties of the slurry such as the thickening time, compressive strength, set time, and rheology. Hydraulic cement compositions are used in both primary cementing operations and secondary cementing operations.

Most primary and secondary cementing applications are carried out using Portland cement, which is a type of hydraulic cement. For example, Portland cement includes a mixture of compounds such as dicalcium silicate (Ca₂SiO₄), tricalcium silicate (Ca₃SiO₅), tricalcium aluminate (3CaO·Al₂O₃), tetracalcium aluminoferrite (4CaO·Al₂O₃Fe₂O₃), and calcium sulfate (CaSO₄). Upon reaction with water, compounds such as calcium hydroxide (Ca(OH)₂)) and calcium silicate hydrate (Ca₂H₂O+Si) are formed.

In a primary cementing operation, a hydraulic cement slurry is pumped into the annular space between the wellbore wall and the exterior of a string of pipe such as a casing or liner disposed in the wellbore. The slurry is allowed to harden and set in the annular space thereby forming an annular sheath of hardened, substantially impermeable cement therein. The cement sheath physically supports and positions the pipe string in the wellbore and bonds the exterior surface of the pipe string to the wall of the wellbore thereby preventing undesirable migration of fluids between zones or formations penetrated by the wellbore.

Examples of secondary cementing operations (also referred to as remedial cementing operations) include squeeze cement jobs and plug cement jobs. In a squeeze cement job, a hydraulic cement slurry is forced through holes or splits in the casing or liner to repair a problem associated with a primary cement job or some other type of well problem. In a plug cement job, a hydraulic cement slurry is used to plug a highly permeable zone or fracture in the well, plug cracks or holes in the casing, or address one or more other problems associated with the casing or well.

Regardless of the type of operation in which they are used, hydraulic cement compositions are often used in applications that are or will become associated with a relatively high level of carbon dioxide (CO₂). For example, many geological formations in which hydraulic cement compositions are used are naturally associated with relatively high levels of carbon dioxide. Even if carbon dioxide is not naturally present in a formation in which a hydraulic cement composition is used, it may be subsequently injected into the formation thereby creating a carbon dioxide environment therein.

For example, carbon dioxide may be added to a geological formation in which a hydraulic cement composition has been used in connection with enhanced oil recovery techniques that involve carbon dioxide. An example of such a technique is a water flooding operation in which carbon dioxide is injected into the formation together with water through one or more injection wells to drive hydrocarbons in the formation toward one or more production wells. Such an operation can create a carbon dioxide environment in the formation.

As another example, carbon dioxide is often added to a geological formation in which a hydraulic cement composition has been used to dispose of the carbon dioxide in the formation. For example, to reduce greenhouse gas emissions into the Earth's atmosphere, captured carbon dioxide is often injected into depleted oil and gas reservoirs for disposal and long-term storage therein. This also can create a carbon dioxide environment in the formation.

Unfortunately, carbon dioxide that is present in a wellbore and/or associated formation in which a hydraulic cement composition or slurry has been used, either naturally or due to being injected therein, can be corrosive to the cement composition. For example, carbon dioxide gas (CO₂) slowly reacts with calcium hydroxide and calcium silicate hydrate in a hardened and set hydraulic cement composition to form calcium carbonate (CaCO₃) and ultimately water-soluble calcium bicarbonate (Ca(HCO₃)₂), which are both corrosive compounds. Carbon dioxide gas can also dissolve in water present in the formation to form corrosive carbonic acid (H₂CO₃).

Due to the above reactions, the integrity of the hardened and set hydraulic cement structures in the wellbore and/or formation can be compromised, thereby causing potentially significant damage to the well. For example, calcium carbonate, calcium bicarbonate, and carbonic acid can react with and penetrate the hardened hydraulic cement thereby lowering the compressive strength thereof. The compressive strength of the cement can decrease, and the permeability of the cement can increase, thereby resulting in cement-cement fractures and the formation of micro-annuli in the hardened and set cement structures. Such fractures and micro-annuli can provide channels for carbon dioxide and other fluids which exacerbates the corrosion. The resulting damage to the wellbore can negatively impact the ability to use the wellbore and result in a significant economic loss. For example, corrosion of the annular cement sheath associated with an oil and gas well can cause the cement sheath to fail resulting in undesired migration of fluids between the formation and well bore and other serious problems.

In view of the above problems, hydraulic cement compositions and slurries have been developed that are resistant to corrosion by carbon dioxide and other compounds formed by the reaction of carbon dioxide with other components present in a wellbore and/or geological formation. An example is calcium phosphate cement. However, due to the cost of materials and complexities in design, such hydraulic cement compositions tend to be expensive. There is a need for carbon dioxide-resistant hydraulic cement compositions and slurries that are relatively inexpensive and easy to prepare and use.

### BRIEF DESCRIPTION OF THE DRAWINGS

The drawings included with this application illustrate certain aspects of specific embodiments of the method, composition, and slurry disclosed herein. However, the embodiments disclosed herein, as shown by the drawings, should not be viewed as the only embodiments of the method, composition, and slurry. The subject matter disclosed herein is capable of considerable modifications, alterations, combinations, and equivalents in form and function, as will occur to those skilled in the art with the benefit of this disclosure. For example, the specific views in the drawings are not representative of the exact size of the items shown.

FIG. 1 illustrates a system for the preparation and delivery of a cement composition to a wellbore in accordance with aspects of the present disclosure.

FIG. 2A illustrates surface equipment that may be used in the placement of a cement composition in a wellbore in accordance with aspects of the present disclosure.

FIG. 2B illustrates the placement of a cement composition into a wellbore annulus in accordance with aspects of the present disclosure.

FIG. 3 illustrates how hydraulic cement samples were subjected to carbon dioxide in a carbonated water bath in accordance with Examples 1 and 4 herein.

FIG. 4 is a graph corresponding to Example 2 herein and illustrating the results of a thermogravimetric analysis carried out on a test sample that did not include an anti-corrosion agent.

FIG. 5 is another graph corresponding to Example 2 herein and illustrating the results of a thermogravimetric analysis carried out on a test sample that did not include an anti-corrosion agent.

FIG. 6 is another graph corresponding to Example 2 herein and illustrating the results of a thermogravimetric analysis carried out on a test sample that included tris (hydroxymethyl)aminomethane as a carbon dioxide anti-corrosion agent.

FIG. 7 is another graph corresponding to Example 2 herein and illustrating the results of a thermogravimetric analysis carried out on a test sample that included tris (hydroxymethyl)aminomethane as a carbon dioxide anti-corrosion agent.

FIG. 8 is a graph corresponding to Example 3 herein and illustrating the results of a Powder X-ray Diffraction (PXRD) analysis carried out on a test sample that did not include an anti-corrosion agent.

FIG. 9 is a graph corresponding to Example 3 herein and illustrating the results of a Powder X-ray Diffraction (PXRD) analysis carried out on a test sample that included tris (hydroxymethyl)aminomethane as a carbon dioxide anti-corrosion agent.

### DETAILED DESCRIPTION

The present disclosure may be understood more readily by reference to this detailed description as well as to the examples included herein. For simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures, and components have not been described in detail so as not to obscure the related relevant feature being described. Also, the description is not to be considered as limiting the scope of the examples described herein. The drawings are not necessarily to scale, and the proportions of certain parts have been exaggerated to better illustrate details and features of the present disclosure.

As used herein and in the appended claims, a “well” means a wellbore extending into the ground and a subterranean formation penetrated by the wellbore. For example, a well can be an oil well, a natural gas well, a water well, or any combination thereof. The phrase “cementing a well” includes both primary and remedial cementing operations. The phrase “cement composition” means a cement or cementitious composition and includes cement compositions in both fluid and slurry forms. The phrase “remedial cementing operations” includes secondary cementing operations.

As used herein and in the appended claims, a component that “comprises” or “includes” one or more specified compounds means that the component includes the specified compound(s) alone or includes the specified compound(s) together with one or more additional compounds. A component that “consists of” one or more specified compounds means that the component includes only the specified compound(s). A component that “consists essentially of” one or more specified compounds means that the component consists of the specified compound(s) alone or consists of the specified compound(s) together with one or more additional compounds that do not materially affect the basic properties of the component.

As used herein and in the appended claims, unless stated otherwise, an expressed percent by weight of a component is based on a dry weight basis.

In one aspect, a hydraulic cement composition is provided herein. In another aspect, a hydraulic cement slurry is provided herein. In yet another aspect, a method of cementing in a carbon dioxide environment is provided herein.

An example of a hydraulic cement composition disclosed herein comprises hydraulic cement, and at least one anti-corrosion agent selected from the group consisting of one or more alkanolamines, one or more derivatives of alkanolamines, and combinations thereof. As used herein and in the appended claims, an “alkanolamine” means a chemical compound that contains at least one hydroxyl functional group (—OH) and at least one amino functional group (—NH₂) on an alkane backbone. An example of the structure of a portion of a chemical compound containing both a hydroxyl functional group (—OH) and an amino functional group (—NH₂) is shown below:

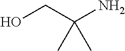

A “derivative of an alkanolamine” means a chemical compound that is not an alkanolamine but includes at least one hydroxyl functional group (—OH) and at least one amino functional group (—NH₂). For example, a derivative of an alkanolamine may not be considered to be an alkanolamine due to the presence of one or more other functional groups, such as carboxyl groups (—COOH) and/or sulfonic groups (—SO₃H).

Both the alkanolamines and the derivatives of alkanolamines are useful as anti-corrosion agents herein are water-soluble and include at least one alcohol functional group and at least one amine functional group. As a result, as shown below, the anti-corrosion agent effectively prevents carbon dioxide corrosion of the hydraulic cement.

For example, the anti-corrosion agent(s) is initially in solid form and can be dry blended with the cement to form the hydraulic cement composition. For example, the hydraulic cement composition can then be mixed with water to form a carbon-dioxide-resistant hydraulic cement slurry.

As used herein and in the appended claims, “hydraulic cement” means cement that sets and hardens upon reaction with water. Any type of hydraulic cement can be used in the composition. Examples of suitable hydraulic cement compositions include Portland cement, pozzolanic cement, Portland Pozzolana cement, sulfate-resisting cement, low-heat cement, and expansive cement.

For example, the hydraulic cement of the hydraulic cement composition can be Portland Cement. For example, the Portland cement can be selected from the group consisting of Class A, Class C, Class G, and Class H type Portland cement, all as classified according to API Specification for Materials and Testing (API Specification 10A), published by The American Petroleum Institute (API). For example, rapid hardening Portland Cement and white ordinary Portland cement can be used.

For example, the hydraulic cement of the composition can be pozzolanic cement. For example, the hydraulic cement of the composition can be Portland Pozzolana cement.

For example, the anti-corrosion agent of the hydraulic cement composition can consist of one or more alkanolamines. For example, the one or more alkanolamines can be selected from the group consisting of tris (hydroxymethyl)aminomethane, methanolamine, ethanolamine, diethanolamine, triethanolamine, aminomethyl propanol, N-methylethanolamine, dimethylethanolamine, (2S)-2-amino-3-methylbutan-1-ol, N-methylhydroxylamine, diethylethanolamine, methyl diethanolamine, N,N-diisopropylaminoethanol, methyl diethanolamine, diethylhydroxylamine, and combinations thereof. For example, the one or more alkanolamines can be selected from the group consisting of tris (hydroxymethyl)aminomethane, methanolamine, ethanolamine, diethanolamine, aminomethyl propanol, (2S)-2-amino-3-methylbutan-1-ol, methyl diethanolamine, and combinations thereof. For example, the one or more alkanolamines can be selected from the group consisting of tris (hydroxymethyl)aminomethane, diethanolamine, and combinations thereof.

For example, the anti-corrosion agent of the hydraulic cement composition can be tris (hydroxymethyl)aminomethane. For example, the anti-corrosion agent of the hydraulic cement composition can be diethanolamine.

For example, the anti-corrosion agent of the hydraulic cement composition can consist of one or more derivatives of alkanolamines. For example, the one or more derivatives of alkanolamines can be selected from the group consisting of bis-tris methane, bis-tris propane, 2-(bis(2-hydroxyethyl) amino) acetic acid, N-[tris (hydroxymethyl)methyl]glycine, [tris (hydroxymethyl)methylamino]propane sulfonic acid), 3-N-Bis-(hydroxyethyl)-amino-2-hydroxypropane sulfonic acid, 3-[N-tris (hydroxymethyl)methylamino]-2-hydroxypropane sulfonic acid), N,N-Bis (2-hydroxyethyl)-2-aminoethane sulfonic acid, 2-[[1,3-dihydroxy-2-(hydroxymethyl) propan-2-yl]amino]ethane sulfonic acid, and combinations thereof. For example, the one or more derivatives of alkanolamines can be selected from the group consisting of 2-(bis(2-hydroxyethyl) amino) acetic acid, N-[tris (hydroxymethyl)methyl]glycine, and combinations thereof.

For example, the anti-corrosion agent can be present in the hydraulic cement composition in an amount of at least about 0.2% by weight based on the weight of the hydraulic cement. For example, the anti-corrosion agent) can be present in the hydraulic cement composition in an amount in the range of from about 0.2% to about 40% by weight based on the weight of the hydraulic cement. For example, the anti-corrosion agent can be present in the hydraulic cement composition in an amount in the range of from about 1% to about 30% by weight based on the weight of the hydraulic cement. For example, the anti-corrosion agent can be present in the hydraulic cement composition in an amount in the range of from about 1% to about 10% by weight based on the weight of the hydraulic cement. For example, the anti-corrosion agent can be present in the hydraulic cement composition in an amount in the range of from about 1% to about 4% by weight based on the weight of the hydraulic cement.

An example of a hydraulic cement slurry disclosed herein comprises hydraulic cement; an anti-corrosion agent selected from the group consisting of one or more alkanolamines, one or more derivatives of alkanolamines, and combinations thereof; and water. For example, the hydraulic cement slurry is a carbon-dioxide-resistant hydraulic cement slurry.

As used herein and in the appended claims, a “carbon-dioxide-resistant hydraulic cement slurry” means a hydraulic cement slurry that, upon setting and hardening, resists corrosion in a carbon dioxide environment. A “carbon dioxide environment” means an environment that contains or may contain in the future an amount of carbon dioxide and/or carbonic acid capable of causing corrosion to a hydraulic cement slurry after the slurry sets and hardens. For example, as used herein, a carbon dioxide environment can be an environment that already includes carbon dioxide and/or carbonic acid (for example, a subterranean formation that naturally includes carbon dioxide and water) or an environment that may be subjected to or otherwise include carbon dioxide, carbonic acid and/or water in the future (for example, a subterranean formation in which carbon dioxide is subsequently injected into the formation in connection with an enhanced oil recovery operation carried out therein, or a subterranean formation in which carbon dioxide is subsequently injected into the formation in connection with a captured carbon disposal operation carried out therein).

The hydraulic cement and the anti-corrosion agent of the hydraulic cement slurry are the same as the hydraulic cement and the anti-corrosion agent of the hydraulic cement composition discussed above. Similarly, the amount of the anti-corrosion agent(s) that can be present in the hydraulic cement slurry is the same as the amount of the anti-corrosion agent that can be present in the hydraulic cement composition discussed above. Accordingly, in this respect, the above description of the components of hydraulic cement composition and the amounts thereof are incorporated into the present description of the hydraulic cement slurry.

The amount of hydraulic cement used in the hydraulic cement slurry will depend, for example, on the desired density of the composition and the intended use of the slurry. For example, in forming an annular cement sheath in the annular space between the wellbore wall and the exterior of a casing or liner placed in the wellbore, the slurry can contain hydraulic cement in an amount in the range of from about 20% percent by weight to about 80% percent by weight based on the total weight of the slurry.

For example, the water can be included in the hydraulic cement slurry in an amount sufficient to form a pumpable slurry of the hydraulic cement and/or other solid additives in the slurry. The density of the slurry can vary depending on the application. Generally, the density of the slurry is in the range of from about 12 to about 19 pounds per gallon of water in the slurry.

For example, the hydraulic cement slurry can further comprise one or more additives to affect one or more properties of the hydraulic cement slurry (for example, the thickening time, compressive strength, set time, and rheology of the slurry).

For example, the hydraulic cement slurry can further comprise a fluid loss additive. An example of a suitable fluid loss additive is Halad®-344, a fluid loss additive marketed by Halliburton Energy Services, Inc. and comprising a copolymer of 2-acrylamide-2-propane sulfonic acid and N,N-dimethyl acrylamide. Examples of other types of fluid loss additives that can be used include polymers comprising 2-acrylamide-2-propane sulfonic acid, N,N-dimethyl acrylamide, and vinyl pyrrolidone, polymers of 2-acrylamide-2-propane sulfonic acid and N,N-dimethyl acrylamide grafted on lignin or tannin. For example, the fluid loss additive can be present in the slurry in an amount in the range of from about 0.1% to about 5% by weight based on the weight of the hydraulic cement in the slurry.

For example, the hydraulic cement slurry can further comprise a defoamer. An example of a suitable de-foaming agent is D-AIR 3000L™, a defoamer marketed by Halliburton Energy Services, Inc. and comprising an internal olefin (C14-C18), an alkaline hydrophobic precipitated silica, and polypropylene glycol 4000. For example, the defoamer can be present in the slurry in an amount in the range of from about 0.1% to about 5% by weight based on the weight of the hydraulic cement in the slurry.

For example, the hydraulic cement slurry can further comprise a suspending agent. Examples of suspending agents that can be used include polysaccharides such as diutan gum. A specific example of polysaccharide suspending agent that can be used is SA-1015™, which is marketed by Halliburton Energy Services, Inc. For example, the suspending agent can be present in the slurry in an amount in the range of from about 0.1% to about 2% by weight based on the weight of the hydraulic cement in the slurry.

For example, the hydraulic cement slurry can further comprise a cement retarder. Examples of cement retarders that can be used include synthetic polymers of AMPS-Acrylic acid, lignosulphonates, organic acids, and sugars. For example, the cement retarder can be present in the slurry in an amount in the range of from about 0.1% to about 5% by weight based on the total weight of the slurry.

Other additives that can be utilized in the hydraulic cement slurry include dispersing additives, latex, accelerating agents, silica, elastomers, fibers, hollow beads and foaming agents. High density additives and lightweight additives can be used. The particular additives and the amount of such additives utilized in the slurry will depend on the particular application.

An example of a method of cementing in a carbon dioxide environment disclosed herein comprises: preparing a hydraulic cement slurry; placing the hydraulic cement slurry in the carbon dioxide environment; and allowing the hydraulic cement slurry to harden and set. The hydraulic cement slurry used in the method is the hydraulic cement slurry described above.

For example, the hydraulic cement slurry can be prepared by mixing the components of the slurry together to form a pumpable slurry. For example, the components of the slurry can be mixed together to form a pumpable slurry and introduced into the wellbore on the fly. For example, the hydraulic cement and anti-corrosion agent(s) can be introduced into the wellbore together (as the hydraulic cement composition disclosed herein), or separately introduced into the wellbore on the fly. The anti-corrosion agent(s) can be used in solid or liquid form. Any additives used can also be mixed with the hydraulic cement slurry and introduced into the wellbore in association therewith on the fly. For example, the components of the hydraulic cement slurry can be mixed together using mixing equipment.

The amounts of hydraulic cement and water used in preparing the hydraulic cement slurry will depend, for example, on the desired density of the slurry and the intended use of the slurry. For example, the water can be included in the hydraulic cement slurry in an amount sufficient to form a pumpable slurry of the hydraulic cement and other solid additives in the slurry, for example, in an amount sufficient to form a pumpable slurry having a density in the range of from about 12 to about 19 pounds per gallon of water in the slurry. The slurry ultimately hardens and sets into a hydraulic cement composition (e.g., a carbon dioxide corrosion-resistant hydraulic cement composition).

The prepared hydraulic cement slurry can be placed in a carbon dioxide environment by introducing (e.g., injecting) the slurry into the wellbore and pumping it into the wellbore and/or through the wellbore into the associated formation, depending on the application. For example, the hydraulic cement slurry can be introduced into the well using one or more pumps.

The hydraulic cement slurry can then be allowed to harden and set. The amount of time required for the cement slurry to harden and set depends, for example, on the type of application, wellbore conditions, and other factors known to those skilled in the art.

For example, the method disclosed herein can be used in connection with any cementing application involving a carbon dioxide environment. Examples include cementing applications involving wells (for example, oil, gas, water, and geothermal wells) penetrating subterranean formations, primary and secondary cementing operations, and formation sealing and consolidation applications. Other cementing applications involving a carbon dioxide environment and in which the method disclosed herein can be utilized include the formation of underground cement capsules for storing carbon from power plants and cementing applications used in connection with in situ combustion techniques used in connection with coal gasification.

For example, the method disclosed herein can be used in connection with an enhanced oil and/or gas recovery operation utilized to enhance the production of a hydrocarbon (such as crude oil and/or natural gas) from partially depleted reservoirs thereof. Such a method comprises the steps of: (a) placing one or more injection wells into the subterranean formation, the injection well(s) including a casing cemented into place using a hydraulic cement slurry herein; (b) placing one or more production wells into the subterranean formation, the production well(s) including a casing cemented into place using a hydraulic cement slurry; and (c) injecting a flooding composition including carbon dioxide and water through one or more of the injection wells into the subterranean formation to pressurize the subterranean formation and drive the hydrocarbon toward the production well(s). The hydrocarbon and typically water are then produced through the production well(s).

The production well(s) and injection well(s) can be placed into the subterranean formation by drilling and completion techniques known in the art. Typically, a plurality of injection wells and production wells are placed in an oil field (which can include several acres) adjacent to the subterranean formation(s) of interest. The injection and production wells are strategically positioned and spaced apart in the oil field to effectively and efficiently utilize the pressure created by flooding the formation to drive the hydrocarbon from the injection well(s) toward the production well(s).

The hydraulic cement slurry and method utilized in the enhanced oil and/or gas recovery operation to cement the casing into place in at least one of the production well(s) and injection well(s) are the carbon dioxide corrosion-resistant hydraulic cement slurry and method disclosed herein. For example, the hydraulic cement slurry and method disclosed herein can be utilized to cement the casing into place in all the production wells and injection wells utilized in the enhanced oil and/or gas recovery operation.

In cementing the casing into place, the hydraulic cement slurry disclosed herein is typically pumped through the tubular casing and forced into the annular space between the outside of the casing and the wall of the wellbore. The hydraulic cement slurry then hardens and sets to bond the casing in the wellbore and effectively seal the casing from the formation and carbonic acid and other corrosive fluids that may be present therein.

After the hydraulic cement slurry is set, one or more perforations are formed in the casing and hardened cement to allow fluids to flow between the injection and production wells and the formation. For example, components used to flood the formation can be injected through perforation(s) in the injection well(s) into the formation. Hydrocarbons, water, and other fluids can be forced from the formation through the perforation(s) into the production well(s).

Methods of enhancing the recovery of a hydrocarbon fluid from a subterranean formation by injecting a flooding composition including carbon dioxide and water through one or more injection wells into the subterranean formation to pressurize the formation and drive a hydrocarbon (for example, crude oil and/or natural gas) toward one or more production wells are well known. The flooding composition can be injected through the injection well(s) by alternating the injection of water and carbon dioxide (water alternating gas (WAG) techniques) or by simultaneously injecting water and carbon dioxide (simultaneous water and gas injection (SWAG) techniques). As discussed above, flooding the formation with carbon dioxide and water exposes the cement utilized to seal the casings of the production well(s) and injection well(s) into place and in connection with other applications associated with the wells to carbonic acid and other corrosive compounds.

Many advantages are achieved by the hydraulic cement composition, hydraulic cement slurry, and method disclosed herein. For example, as shown by the examples below, the hardened and set hydraulic cement slurry is very effective in resisting corrosion by high concentrations of carbon dioxide in water under harsh temperature and pressure conditions, for example, conditions that are often associated with downhole environments.

Unless indicated to the contrary, the numerical parameters set forth herein and in the attached claims are approximations that may vary depending upon the desired properties sought to be obtained by the embodiments described herein. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges, some lower limits listed may be greater than some upper limits listed. One skilled in the art will recognize that the selected subset will require the selection of an upper limit in excess of the selected lower limit.

The exemplary cement compositions disclosed herein may directly or indirectly affect one or more components or pieces of equipment associated with the preparation, delivery, recapture, recycling, reuse, and/or disposal of the disclosed cement compositions. For example, the disclosed cement compositions may directly or indirectly affect one or more mixers, related mixing equipment, mud pits, storage facilities or units, composition separators, heat exchangers, sensors, gauges, pumps, compressors, and the like used to generate, store, monitor, regulate, and/or recondition the exemplary cement compositions. The disclosed cement compositions may also directly or indirectly affect any transport or delivery equipment used to convey the cement compositions to a well site or downhole such as, for example, any transport vessels, conduits, pipelines, trucks, tubulars, and/or pipes used to compositionally move the cement compositions from one location to another, any pumps, compressors, or motors (e.g., topside or downhole) used to drive the cement compositions into motion, any valves or related joints used to regulate the pressure or flow rate of the cement compositions, and any sensors (i.e., pressure and temperature), gauges, and/or combinations thereof, and the like. The disclosed cement compositions may also directly or indirectly affect the various downhole equipment and tools that may come into contact with the cement compositions/additives such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

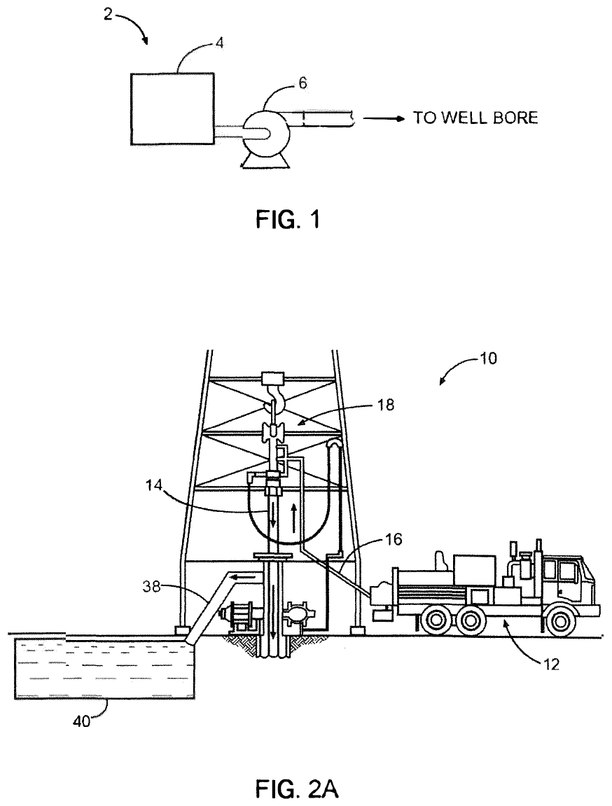

Referring now to FIG. 1, a system that may be used in the preparation of a hydraulic cement composition in accordance with example embodiments described herein will now be described. FIG. 1 illustrates a system 2 for preparation of a cement composition and delivery to a wellbore in accordance with certain embodiments. As shown, the cement composition may be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 may be disposed on one or more cement trucks as will be apparent to those of ordinary skill in the art. In some embodiments, a jet mixer may be used, for example, to continuously mix the composition, including water, as it is being pumped to the wellbore.

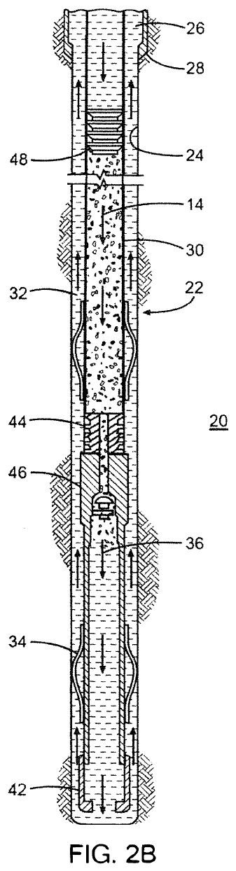

An example technique and system for placing a cement composition into a subterranean formation will now be described with reference to FIGS. 2A and 2B. FIG. 2A illustrates surface equipment 10 that may be used in the placement of a cement composition in accordance with certain embodiments. It should be noted that while FIG. 2A generally depicts a land-based operation, those skilled in the art will readily recognize that the principles described herein are equally applicable to subsea operations that employ floating or sea-based platforms and rigs, without departing from the scope of the disclosure. As illustrated by FIG. 2A, the surface equipment 10 may include a cementing unit 12, which may include one or more cement trucks. The cementing unit 12 may include mixing equipment 4 and pumping equipment 6 (e.g., FIG. 1) as will be apparent to those of ordinary skill in the art. The cementing unit 12 may pump a cement composition 14 through a feed pipe 16 and to a cementing head 18 which conveys the cement composition 14 downhole.

Turning now to FIG. 2B, the cement composition 14 may be placed into a subterranean formation 20 in accordance with example embodiments. As illustrated, a wellbore 22 may be drilled into the subterranean formation 20. While wellbore 22 is shown extending generally vertically into the subterranean formation 20, the principles described herein are also applicable to wellbores that extend at an angle through the subterranean formation 20, such as horizontal and slanted wellbores. As illustrated, the wellbore 22 comprises walls 24. In the illustrated embodiments, a surface casing 26 has been inserted into the wellbore 22. The surface casing 26 may be cemented to the walls 24 of the wellbore 22 by cement sheath 28. In the illustrated embodiment, one or more additional conduits (e.g., intermediate casing, production casing, liners, etc.) shown here as casing 30 may also be placed in the wellbore 22. As illustrated, there is a wellbore annulus 32 formed between the casing 30 and the walls 24 of the wellbore 22 and/or the surface casing 26. One or more centralizers 34 may be attached to the casing 30, for example, to centralize the casing 30 in the wellbore 22 prior to and during the cementing operation.

With continued reference to FIG. 2B, the cement composition 14 may be pumped down the interior of the casing 30. The cement composition 14 may be allowed to flow down the interior of the casing 30 through the casing shoe 42 at the bottom of the casing 30 and up around the casing 30 into the wellbore annulus 32. The cement composition 14 may be allowed to set in the wellbore annulus 32, for example, to form a cement sheath that supports and positions the casing 30 in the wellbore 22. While not illustrated, other techniques may also be utilized for the introduction of the cement composition 14. By way of example, reverse circulation techniques may be used that include introducing the cement composition 14 into the subterranean formation 20 by way of the wellbore annulus 32 instead of through the casing 30.

As it is introduced, the cement composition 14 may displace other fluids 36, such as drilling fluids and/or spacer fluids, that may be present in the interior of the casing 30 and/or the wellbore annulus 32. At least a portion of the displaced fluids 36 may exit the wellbore annulus 32 via a flow line 38 and be deposited, for example, in one or more retention pits 40 (e.g., a mud pit), as shown in FIG. 2A. Referring again to FIG. 2B, a bottom plug 44 may be introduced into the wellbore 22 ahead of the cement composition 14, for example, to separate the cement composition 14 from the fluids 36 that may be inside the casing 30 prior to cementing. After the bottom plug 44 reaches the landing collar 46, a diaphragm or other suitable device ruptures to allow the cement composition 14 through the bottom plug 44. In FIG. 2B, the bottom plug 44 is shown on the landing collar 46. In the illustrated embodiment, a top plug 48 may be introduced into the wellbore 22 behind the composition 14. The top plug 48 may separate the cement composition 14 from a displacement fluid 50 and also push the cement composition 14 through the bottom plug 44.

Accordingly, in one embodiment, a hydraulic cement composition is provided herein. The hydraulic cement composition comprises hydraulic cement; and at least one anti-corrosion agent selected from the group consisting of one or more alkanolamines, one or more derivatives of alkanolamines, and combinations thereof.

In another embodiment, a hydraulic cement slurry is provided herein. The hydraulic cement slurry comprises hydraulic cement; and at least one anti-corrosion agent selected from the group consisting of one or more alkanolamines, one or more derivatives of alkanolamines, and combinations thereof; and water.

In yet another embodiment, a method of cementing in a carbon dioxide environment is provided herein. The method comprises preparing a hydraulic cement slurry, placing the hydraulic cement slurry in the carbon dioxide environment, and allowing the hydraulic cement slurry to harden and set. The hydraulic cement slurry comprises a hydraulic cement; at least one anti-corrosion agent selected from the group consisting of one or more alkanolamines, one or more derivatives of alkanolamines, and combinations thereof; and water.

For example, in each of the above embodiments, the hydraulic cement is Portland cement.

For example, in each of the above embodiments, the anti-corrosion agent consists of one or more alkanolamines. For example, in each of the above embodiments, the anti-corrosion agent consists of one or alkanolamines selected from the group consisting of tris (hydroxymethyl)aminomethane, methanolamine, ethanolamine, diethanolamine, triethanolamine, aminomethyl propanol, N-methylethanolamine, dimethylethanolamine, (2S)-2-amino-3-methylbutan-1-ol, N-methylhydroxylamine, diethylethanolamine, methyl diethanolamine, N,N-diisopropylaminoethanol, methyl diethanolamine, diethylhydroxylamine, and combinations thereof. For example, in each of the above embodiments, the anti-corrosion agent consists of one or alkanolamines selected from the group consisting of tris (hydroxymethyl)aminomethane, methanolamine, ethanolamine, diethanolamine, aminomethyl propanol, (2S)-2-amino-3-methylbutan-1-ol, methyl diethanolamine, and combinations thereof. For example, in each of the above embodiments, the anti-corrosion agent consists of one or alkanolamines selected from the group consisting of tris (hydroxymethyl)aminomethane, diethanolamine, and combinations thereof.

For example, in each of the above embodiments, the anti-corrosion agent is tris (hydroxymethyl)aminomethane. For example, in each of the above embodiments, the anti-corrosion agent is diethanolamine.

For example, in each of the above embodiments, the anti-corrosion agent consists of one or more derivatives of alkanolamines. For example, in each of the above embodiments, the one or more derivatives of alkanolamines are selected from the group consisting of bis-tris methane, bis-tris acetic acid, N-propane, 2-(bis(2-hydroxyethyl) amino) [tris (hydroxymethyl)methyl]glycine, [tris (hydroxymethyl)methylamino]propane sulfonic acid), 3-N-Bis-(hydroxyethyl)-amino-2-hydroxypropane sulfonic acid, 3-[N-tris (hydroxymethyl)methylamino]-2-hydroxypropane sulfonic acid), N,N-Bis (2-hydroxyethyl)-2-aminoethane sulfonic acid, 2-[[1,3-dihydroxy-2-(hydroxymethyl) propan-2-yl]amino]ethane sulfonic acid, and combinations thereof. For example, in each of the above embodiments, the derivatives of alkanolamines are selected from the group consisting of 2-(bis(2-hydroxyethyl) amino) acetic acid, N-[tris (hydroxymethyl)methyl]glycine, and combinations thereof.

For example, in each of the above embodiments, the anti-corrosion agent is present in the composition or slurry (as the case may be) in an amount of at least about 0.2% by weight based on the weight of the hydraulic cement. For example, in each of the above embodiments, the anti-corrosion agent is present in the composition or slurry (as the case may be) in an amount in the range of from about 0.2% to about 40% by weight based on the weight of the hydraulic cement. For example, in each of the above embodiments, the anti-corrosion agent is present in the composition or slurry (as the case may be) in an amount in the range of from about 1% to about 30% by weight based on the weight of the hydraulic cement. For example, in each of the above embodiments, the anti-corrosion agent is present in the composition or slurry (as the case may be) in an amount in the range of from about 1% to about 10% by weight based on the weight of the hydraulic cement. For example, in each of the above embodiments, the anti-corrosion agent is present in the composition or slurry (as the case may be) in an amount in the range of from about 1% to about 4% by weight based on the weight of the hydraulic cement.

The present invention is exemplified by the following examples, which are given by way of example only and should not be taken as limiting of the present invention in any way.

### EXAMPLES

The following examples illustrate specific embodiments consistent with the present disclosure but do not limit the scope of the disclosure or the appended claims. Concentrations and percentages with respect to a hydraulic cement composition or slurry are percent by weight, based on the weight of hydraulic cement in the composition or slurry (“% BWOC”), unless otherwise indicated. Unless stated otherwise, an expressed percent by weight of a component is based on a dry weight basis.

### Example 1

### Exposure of Cement Compositions to Carbon Dioxide Environment-HMAM

Hydraulic cement slurries with and without tris (hydroxymethyl)aminomethane (“HMAM”) were prepared. The slurries were mixed in accordance with API Recommended Practice 10B-2, § 5.3.4 (2^{nd} Ed. April 2013, reaffirmed April 2019). The first slurry, Slurry-1 (neat cement-control) did not include HMAM. The second slurry, Slurry-2, did include HMAM. Each slurry was prepared to have a density of 15.8 pounds per gallon.

The components (and amounts thereof) of each slurry are shown by Table 1 below:

TABLE 1
Hydraulic Cement Slurries at 15.8 lb/gal - HMAM

| | Slurry - 1 - without HMAM | Slurry - 2 - with |
|---|---|---|
| Components | (neat cement - control) | HMAM |
| Portland Class G | 100 | 100 |
| Hydraulic Cement (%) | | |
| Portland Class G | 783.9 | 773.5 |
| Hydraulic Cement | | |
| (grams in 600 mL mix | | |
| volume) | | |
| HMAM¹ (% BWOC) | — | 3.5 |
| SA-1015 ™ suspending | 0.4 g | 0.4 g |
| agent² | | |
| D-AIR 3000L ™ | 0.7 g | 0.7 g |
| defoamer³ | | |
| Water (L/100 Kg) | 44.876 | 43.36 |
| Water Requirement | 5.055 | 4.884 |
| (gps)⁴ | | |
| Water/Cement Ratio (%) | 44.8 | 43.3 |

¹The HMAM was present in Slurry - 2 in an amount of 3.5% by weight, based on the weight of the hydraulic cement.
²A suspending agent marketed by Halliburton Energy Services, Inc. The suspending agent was present in the hydraulic cement slurry in an amount of 0.05% by weight, based on the weight of the hydraulic cement.
³A defoamer marketed by Halliburton Energy Services, Inc. (0.01 gallon per sack of cement (gps)).
⁴Gallons per sack of hydraulic cement.

The mixed slurries were placed in cylindrical brass molds and cured therein at 140° F. and atmospheric pressure for 7 days in a water bath. After the 7-day cure period, the hardened and set slurries (now in the form of cylinders) were removed from the molds and tested as set forth below.

Multiple hardened and set cylindrical-shaped test samples from Slurry-1 (control) and multiple hardened and set cylindrical-shaped test samples from Slurry-2 (containing HMAM) were then placed in a carbonated water bath, and the carbonated water bath was maintained at 140° F. and approximately 2500 psi for over 60 days. As explained below, a sample of each of Slurry-1 and Slurry-2 was tested after 14, 30, and 60 days in the water bath.

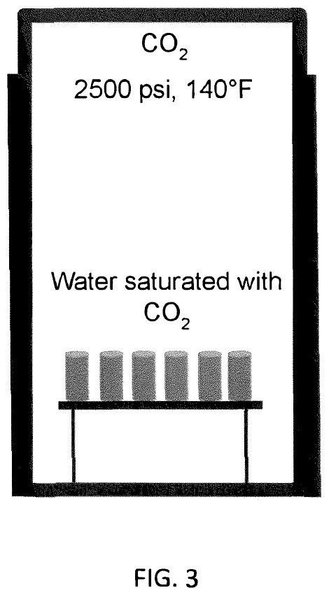

The carbonated water bath with the test samples therein was set up as shown FIG. 3 of the drawings. As illustrated, the cylindrical-shaped test samples were placed on a perforated Teflon stand in a curing chamber. Approximately 800 mL of deionized water was then added to the curing chamber such that the test samples were completely submerged therein. The chamber lid was then tightened, and carbon dioxide was injected into the chamber until the pressure in the chamber reached approximately 2000 psi. Next, the chamber was heated to 140° F., which caused the pressure in the chamber to increase to approximately 2500 psi. The chamber was maintained at 140° F. and approximately 2500 psi throughout the entire test period.

In order to check the extent of carbonation (corrosion) of the test samples by the carbon dioxide (carbonic acid), phenolphthalein dye tests were carried out on a test sample from each of Slurry-1 and Slurry-2 after 14, 30, and 60 days. Phenolphthalein is sensitive to pH value and undergoes a color change from orange in strongly acidic environments (pH<1) to colorless in mildly acidic to neutral environments (pH 1-8.3) and to pink in alkaline conditions (pH 8.3-10).

The phenolphthalein dye tests were carried out on each test sample by first removing the test sample from the carbonated water bath and cutting it in half in a direction perpendicular to the longitudinal axis. Phenolphthalein dye was then applied to the surface of the cut cylinder. The depth of the dye penetration was then compared to a sample that was not exposed to carbon dioxide.

It was observed that after 14 days in the carbonated water bath, the test sample that did not include HMAM (control) included a small outer layer that did not turn pink, indicating partial carbonation of the sample. After 30 days in the carbonated water bath, the carbonation front in the test sample that did not include HMAM (control) had progressed inside the core. After 60 days in the carbonated water bath, the carbonation front in the test sample that did not include HMAM (control) had progressed even further inside the core (approximately halfway into the core).

On the other hand, after 14 days in the carbonated water bath, the test sample that included HMAM (corresponding to Slurry-2) had turned completely pink, indicating no appreciable carbonation of the sample. The same result was achieved for the test sample that included HMAM (corresponding to Slurry-2) after 30 days and 60 days in the test chamber.

Thus, the test results indicate that the addition of HMAM to a hydraulic cement composition prevents problematic corrosion of the hardened and set cement composition in a carbon dioxide environment.

### Example 2

### Thermogravimetric Analysis (TGA) of Test Samples-HMAM

In order to further confirm the results, test samples from both Slurry-1 (control) and Slurry-2 (including HMAM), as prepared and immersed in the carbonated water bath as described in Example 1 above, were subjected to thermogravimetric analyses (TGA), both after the initial 7-day curing period (prior to being immersed in a carbonated water bath) and after 30 days of carbon dioxide exposure in the water bath. Each TGA analysis was done on a TA Instrument (TQ 500) by heating the test sample (at approximately 7 mg-8 mg) at a constant rate (10° C./min) of temperature increase in a nitrogen atmosphere. The sample weight change or the percent of weight change was recorded with respect to the temperature rise.

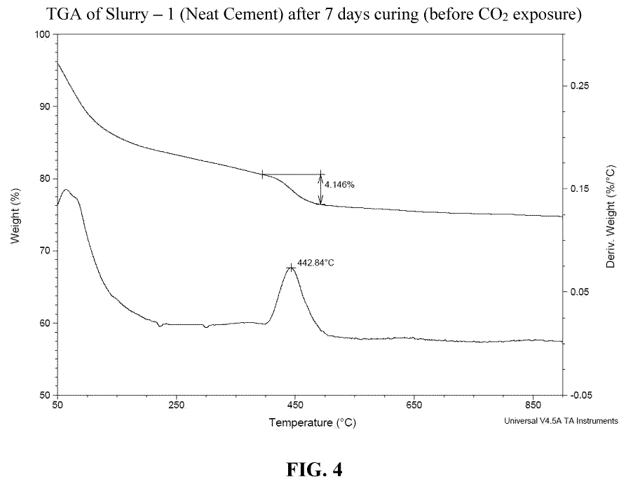

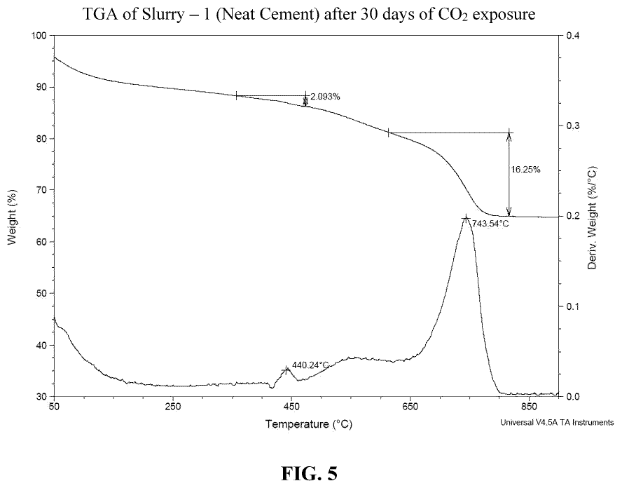

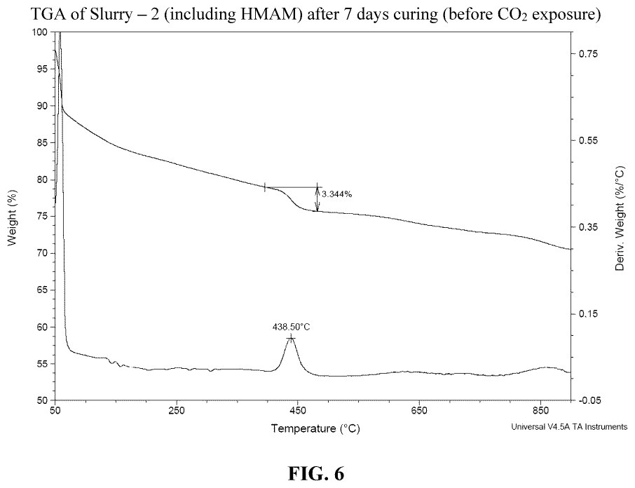

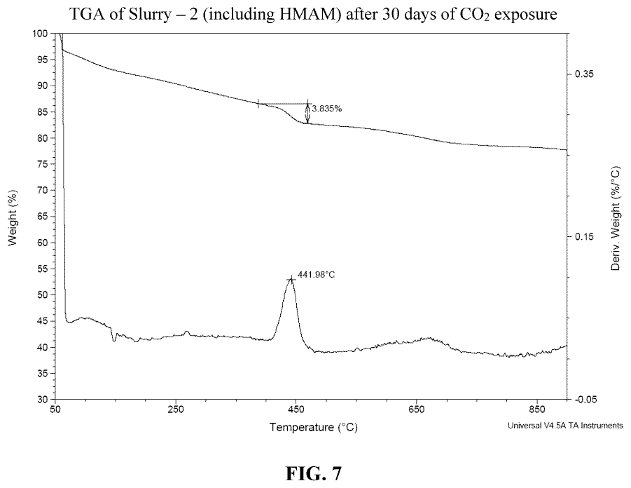

Loss on ignition charts for the hydraulic cement test samples corresponding to Slurry-1 (control) after the initial 7-day curing period (before carbon dioxide exposure) and after 30 days of carbon dioxide exposure are shown by FIGS. 4 and 5, respectively, of the drawings. Similarly, loss on ignition charts for the hydraulic cement test samples corresponding to Slurry-2 (including HMAM) after the initial 7-day curing period (before carbon dioxide exposure) and after 30 days of carbon dioxide exposure are shown by FIGS. 6 and 7, respectively, of the drawings.

As shown, the test samples corresponding to Slurry-2 (including HMAM) showed only one small peak near ˜400° C., both before and after carbon dioxide exposure (see FIGS. 6 and 7), indicating the presence of Portlandite, Ca(OH)₂. On the other hand, the test sample corresponding to Slurry-1 showed another big peak at ˜740° C. after being exposed to carbon dioxide (see FIG. 5), indicating the presence of calcium carbonate (CaCO₃). The absence of a calcium carbonate (CaCO₃) peak in FIG. 7 confirms that the HMAM in the test sample helped mitigate corrosion of the cured hydraulic cement in a carbon dioxide environment.

Thus, the TGA test results confirm that the addition of HMAM to a hydraulic cement composition prevents problematic corrosion of the hardened and set cement composition in a carbon dioxide environment.

### Example 3

### Effect of HMAM on Portland Cement

In order to confirm the anti-corrosive effect of HMAM on the Portland cement in the samples, test samples from both Slurry-1 (control) and Slurry-2 (including HMAM), as prepared and immersed in the carbonated water bath as described in Example 1 above, were subjected to tests to analyze the Powder X-ray Diffraction (PXRD) patterns of the samples after 30 days of carbon dioxide exposure in the water bath. The PXRD tests were used to understand different phases of the mineralogical composition and identify any solid materials therein. For example, in the present application, the PXRD tests were used to identify phases of the cured cement samples.

The tests were carried out by first passing the powdered samples through a 200-mesh screen. The available phases of the mineralogical composition associated with the cured cement samples were determined with an X-ray Diffraction (XRD) analyzer using CuKα as the source of X-ray. The output data was then analyzed.

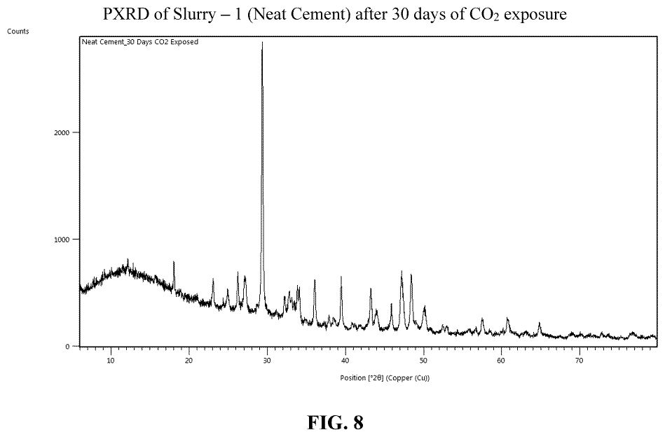

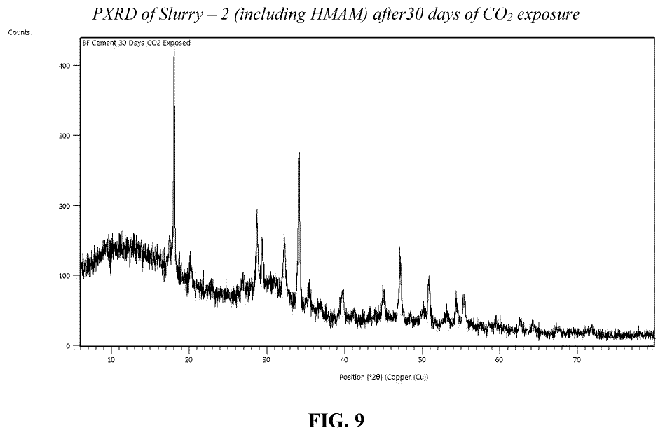

The results of the tests are shown by FIGS. 8 and 9 and Table 2 below. As shown, the crystalline peak values were normalized and reported as the approximate percentage by using the semi-quantification/Rietveld method.

TABLE 2
PXRD results after 30 days of CO₂ exposure -
Approximate % using Rietveld Refinement

| | Slurry - 1 - without HMAM | Slurry - 2 - with |
|---|---|---|
| | (neat cement - control) | HMAM |
| % Amorphous | 57 | 76 |
| % Mineralogical | | |
| Alite, C3S | 1 | 8 |
| Belite, C2S | 0 | 3 |
| Ferrite/Brownmillerite, | 5 | 1 |
| C4AF | | |
| Portlandite | 2 | 10 |
| Calcite | 35 | 2 |

The calcite (i.e., CaCO₃) content was found more in Slurry-1 than Slurry-2, whereas Portlandite (i.e., Ca(OH)₂) was found more in Slurry-2 than Slurry-2. Thus, the PXRD results are quite in line and supportive of the test results set forth in Examples 2 and 3 above.

### Example 4

### Crush Strength Tests-HMAM

In order to understand the effect of HMAM on the compressive strength of the Portland cement, test samples from both Slurry-1 (control) and Slurry-2 (including HMAM), as prepared in Example 1 above, were subjected to crush compressive strength tests after the initial 7-day curing period (prior to being immersed in a carbonated water bath).

In carrying out the tests, the cured cement samples were first removed from the mold and leveled flat. Next, crush compressive strength tests were performed on a Tinius Olsen load frame, which measures the force required to break the specimen. This force is then converted to a force per area (such as psi), based on the surface area of the specimen in contact with one of the loading platens of the press.

The results of the crush strength tests indicate the strength of the corresponding cement slurry after it has been pumped into a well and allowed to set static. Under these conditions, the slurry is subjected to temperature (and normally, pressure) for various durations of time. The slurries may be cured at bottom-hole conditions or the conditions at a specific point of interest.

It was determined that after 7 days, the sample of Slurry-1 (control) had a crush compressive strength of 7490 psi. After 7 days, the sample of Slurry-2 (containing HMAM) had a crush compressive strength of 6810 psi. Thus, the addition of HMAM did not significantly impact the crush compressive strength of the hydraulic cement composition.

### Example 5

### Exposure of Cement Compositions to Carbon Dioxide Environment-DEA

A hydraulic cement slurry including diethanolamine (“DEA”) (Slurry-3) was prepared, cured, and formed into a test sample, and a phenolphthalein dye test was carried out on the test sample, as described in Example 1 above. For example, the slurry was prepared to have a density of 15.8 pounds per gallon. The chamber was maintained at 140° F. and approximately 2500 psi throughout the entire test period. The results were compared to the results obtained by Slurry-1 (neat cement-control) as set forth in Example 1.

The components (and amounts thereof) of Slurry-1 and Slurry-3 are shown by Table 3 below:

TABLE 3
Hydraulic Cement Slurries at 15.8 lb/gal - DEA

| | Slurry - 1 - without DEA | Slurry - 3 - with |
|---|---|---|
| Components | (neat cement - control) | DEA |
| Portland Class G | 100 | 100 |
| Hydraulic Cement (%) | | |
| Portland Class G | 783.9 | 780.7 |
| Hydraulic Cement | | |
| (grams in 600 mL mix | | |
| volume) | | |
| DEA¹ (gps) | — | 0.3 |
| SA-1015 ™ suspending | 0.4 g | 0.4 g |
| agent² | | |
| D-AIR 3000L ™ | 0.7 g | 0.7 g |
| defoamer³ | | |
| Water (L/100 Kg) | 44.876 | 42.516 |
| Water Requirement | 5.055 | 4.789 |
| (gps)⁴ | | |
| Water/Cement Ratio (%) | 44.8 | 42.4 |

¹The DEA, a liquid compound, was used in Slurry - 3 in an amount of 0.3 gallons per sack.
²A suspending agent marketed by Halliburton Energy Services, Inc. The suspending agent was present in the hydraulic cement slurry in an amount of 0.05% by weight, based on the weight of the hydraulic cement.
³A defoamer marketed by Halliburton Energy Services, Inc. (0.01 gallon per sack of cement (gps)).
⁴Gallons per sack of hydraulic cement.

The mixed Slurry-3 was placed in cylindrical brass molds and cured therein at 140° F. and atmospheric pressure for 7 days in a water bath. After the 7-day cure period, the hardened and set slurries (now in the form of cylinders) were removed from the molds and tested as set forth below.

A hardened and set cylindrical-shaped test sample from Slurry-3 (containing DEA) was then placed in a carbonated water bath, and the water bath was maintained at 140° F. and approximately 2500 psi for the test period A phenolphthalein dye test was carried out on the Slurry-3 test sample after 14 days in the water bath, as described above.

As described above, it was observed that after 14 days in the carbonated water bath, the test sample that did not include an anti-corrosion agent (Slurry-1 (control)) included a small outer layer that did not turn pink, indicating partial carbonation of the sample. On the other hand, after 14 days in the carbonated water bath, the test sample that included DEA (corresponding to Slurry-3) had turned completely pink after 14 days, indicating no appreciable carbonation of the sample.

Thus, the test results indicate that the addition of DEA to a hydraulic cement composition also prevents problematic corrosion of the hardened and set cement composition in a carbon dioxide environment.

Therefore, the present hydraulic cement composition, slurry, and method are well adapted to attain the ends and advantages mentioned, as well as those that are inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method of cementing in a carbon dioxide environment, comprising:
preparing a hydraulic cement slurry, said hydraulic cement slurry including:
a hydraulic cement;
an anti-corrosion agent selected from the group consisting of one or more alkanolamines, one or more derivatives of alkanolamines, and combinations thereof; and
water;
placing said hydraulic cement slurry in said carbon dioxide environment; and
allowing said hydraulic cement slurry to harden and set.

2. The method of claim 1, wherein said anti-corrosion agent consists of one or more alkanolamines.

3. The method of claim 2, wherein one or more alkanolamines are selected from the group consisting of tris (hydroxymethyl)aminomethane, methanolamine, ethanolamine, diethanolamine, triethanolamine, aminomethyl propanol, N-methylethanolamine, dimethylethanolamine, (2S)-2-amino-3-methylbutan-1-ol, N-methylhydroxylamine, diethylethanolamine, methyl diethanolamine, N,N-diisopropylaminoethanol, methyl diethanolamine, diethylhydroxylamine, and combinations thereof.

4. The method of claim 3, wherein said one or more alkanolamines are selected from the group consisting of tris (hydroxymethyl)aminomethane, methanolamine, ethanolamine, diethanolamine, aminomethyl propanol, (2S)-2-amino-3-methylbutan-1-ol, methyl diethanolamine, and combinations thereof.

5. The method of claim 4, wherein said one or more alkanolamines are selected from the group consisting of tris (hydroxymethyl)aminomethane, diethanolamine, and combinations thereof.

6. The method of claim 5, wherein said anti-corrosion agent is tris (hydroxymethyl)aminomethane.

7. The method of claim 5, wherein said anti-corrosion agent is diethanolamine.

8. The method of claim 1, wherein said anti-corrosion agent consists of one or more derivatives of alkanolamines.

9. The method of claim 8 wherein said one or more derivatives of alkanolamines are selected from the group consisting of bis-tris methane, bis-tris propane, 2-(bis(2-hydroxyethyl) amino) acetic acid, N-[tris (hydroxymethyl)methyl]glycine, [tris (hydroxymethyl)methylamino]propane sulfonic acid), 3-N-Bis-(hydroxyethyl)-amino-2-hydroxypropane sulfonic acid, 3-[N-tris (hydroxymethyl)methylamino]-2-hydroxypropane sulfonic acid), N,N-Bis (2-hydroxyethyl)-2-aminoethane sulfonic acid, 2-[[1,3-dihydroxy-2-(hydroxymethyl) propan-2-yl]amino]ethane sulfonic acid, and combinations thereof.

10. The method of claim 9, wherein said one or more derivatives of alkanolamines are selected from the group consisting of 2-(bis(2-hydroxyethyl) amino) acetic acid, N-[tris (hydroxymethyl)methyl]glycine, and combinations thereof.

11. The method of claim 1, wherein said anti-corrosion agent is present in said hydraulic cement slurry in an amount of at least about 0.2% by weight based on the weight of said hydraulic cement.

12. The method of claim 1, wherein said hydraulic cement slurry is placed in said carbon dioxide environment using one or more pumps.

13. A hydraulic cement composition, comprising:
hydraulic cement; and
an anti-corrosion agent selected from the group consisting of one or more alkanolamines, one or more derivatives of alkanolamines, and combinations thereof.

14. The hydraulic cement composition of claim 13, wherein said anti-corrosion agent consists of one or more alkanolamines selected from the group consisting of tris (hydroxymethyl)aminomethane, methanolamine, ethanolamine, diethanolamine, triethanolamine, aminomethyl propanol, N-methylethanolamine, dimethylethanolamine, (2S)-2-amino-3-methylbutan-1-ol, N-methylhydroxylamine, diethylethanolamine, methyl diethanolamine, N,N-diisopropylaminoethanol, methyl diethanolamine, diethylhydroxylamine, and combinations thereof.

15. The hydraulic cement composition of claim 14, wherein said one or more alkanolamines are selected from the group consisting of tris (hydroxymethyl)aminomethane, diethanolamine, and combinations thereof.

16. The hydraulic cement composition of claim 13, wherein said anti-corrosion agent consists of one or more derivatives of alkanolamines selected from the group consisting of bis-tris methane, bis-tris propane, 2-(bis(2-hydroxyethyl) amino) acetic acid, N-[tris (hydroxymethyl)methyl]glycine, [tris (hydroxymethyl)methylamino]propane sulfonic acid), 3-N-Bis-(hydroxyethyl)-amino-2-hydroxypropane sulfonic acid, 3-[N-tris (hydroxymethyl)methylamino]-2-hydroxypropane sulfonic acid), N,N-Bis (2-hydroxyethyl)-2-aminoethane sulfonic acid, 2-[[1,3-dihydroxy-2-(hydroxymethyl) propan-2-yl]amino]ethane sulfonic acid, and combinations thereof.

17. A hydraulic cement slurry, comprising:
hydraulic cement;
an anti-corrosion agent selected from the group consisting of one or more alkanolamines, one or more derivatives of alkanolamines, and combinations thereof; and
water.

18. The hydraulic cement slurry of claim 17, wherein said anti-corrosion agent consists of one or more alkanolamines selected from the group consisting of tris (hydroxymethyl)aminomethane, methanolamine, ethanolamine, diethanolamine, triethanolamine, aminomethyl propanol, N-methylethanolamine, dimethylethanolamine, (2S)-2-amino-3-methylbutan-1-ol, N-methylhydroxylamine, diethylethanolamine, methyl diethanolamine, N,N-diisopropylaminoethanol, methyl diethanolamine, diethylhydroxylamine, and combinations thereof.

19. The hydraulic cement slurry of claim 18, wherein said one or more alkanolamines are selected from the group consisting of tris (hydroxymethyl)aminomethane, diethanolamine, and combinations thereof.

20. The hydraulic cement slurry of claim 17, wherein said anti-corrosion agent consists of one or more derivatives of alkanolamines selected from the group consisting of. bis-tris methane, bis-tris propane, 2-(bis(2-hydroxyethyl) amino) acid, acetic N-[tris (hydroxymethyl)methyl]glycine, [tris (hydroxymethyl)methylamino]propane sulfonic acid), 3-N-Bis-(hydroxyethyl)-amino-2-hydroxypropane sulfonic acid, 3-[N-tris (hydroxymethyl)methylamino]-2-hydroxypropane sulfonic acid), N,N-Bis (2-hydroxyethyl)-2-aminoethane sulfonic acid, 2-[[1,3-dihydroxy-2-(hydroxymethyl) propan-2-yl]amino]ethane sulfonic acid, and combinations thereof.
